(19) United States
(12) Patent Application Publication
(10) Pub. No.: US 2023/0315070 A1
(43) Pub. Date: Oct. 5, 2023

(54) PSEUDO DEFECTIVE PRODUCT DATA GENERATOR

(71) Applicant: HONDA MOTOR CO., LTD., Tokyo (JP)

(72) Inventors: Toshikazu KARUBE, Tokyo (JP); Masahiro KAMIMURA, Tokyo (JP); Jin FUKUMITSU, Tokyo (JP)

(21) Appl. No.: 18/191,118

(22) Filed: Mar. 28, 2023

(30) Foreign Application Priority Data
Mar. 30, 2022 (JP) 2022-057226

(51) Int. Cl. G05B 19/418

(52) U.S. Cl. CPC G05B 19/41875; G05B 19/4183

(57) ABSTRACT

Included are a first feature quantity conversion unit that converts a plurality of pieces of acquired actual defective product data respectively into actual feature quantities, a predicted feature quantity generation unit that generates a predicted feature quantity group by learning of a feature quantity generation model, a pseudo defective product data generation unit that generates a pseudo defective product data group by learning of an image generation model, a second feature quantity conversion unit that converts the pseudo defective product data group to acquire as a pseudo feature quantity group, a feature quantity distribution comparison unit that compares distributions between the predicted feature quantity group and the pseudo feature quantity group to calculate a feature quantity error as a residual error, and a pseudo defective product data quality determination unit that determines the quality of the generated pseudo defective product data group, based on the feature quantity error.

### BACKGROUND

### Technical Field

The present invention relates to a pseudo defective product data generator that generates a large amount of defective product data of an inspected object in a pseudo manner for use in learning by an inspection device or the like having a machine learning function that uses a neural network.

### Related Art

In recent years, with an inspection device having a machine learning function that uses a neural network, progress has been made on the development of automation technology in an inspection operation for determining whether inspected objects such as various types of industrial products or parts are each a normal product (non-defective product) or an abnormal product (defective product). In such an inspection device, learning is performed by reading many pieces of image data of appearances of the inspected objects that have been classified as the non-defective products and the defective products. Then, the inspection device that has learned classification criteria becomes capable of classifying a new inspected object that has been imaged by a camera as a non-defective product or a defective product.

As described above, in the learning by the inspection device, image data of the non-defective product and image data of the defective product are used. In order to improve inspection accuracy, many pieces of image data are necessary for both the non-defective product and the defective product. However, in a manufacturing site of industrial products and the like, in general, the products are manufactured to produce defective products as few as possible. Hence, there are a lot of non-defective products, whereas there are a very few defective products. For this reason, it is more difficult to collect the image data of the defective product (hereinafter, referred to as “defective product data”) than the image data of the non-defective product (hereinafter, referred to as “non-defective product data”), which is relatively easily collectable. Therefore, creation of the defective product data in a pseudo manner is taken into consideration. As a creation device, for example, the device described in JP 2005-156334 A is known.

Such a pseudo defective product data creation device first extracts differential data between the non-defective product image and the defective product image. Next, the number of pieces of pseudo defective product data that should be created (creation number) is set. Then, a random number value is acquired from a random number generation unit for every creation of a single piece of pseudo defective product data, a write position of the differential data is determined by use of the random number value, and the non-defective product image and the differential data are synthesized. By repeating such synthesis processing the creation number of times, pieces of pseudo defective product data for the creation number of times that has been set are created.

### SUMMARY

In the above-described conventional pseudo defective product data creation device, pieces of defective product data similar to each other are created, in some cases. For this reason, even though a large amount of such defective product data is caused to be learned, it may not be possible to improve determination accuracy of the inspection device sufficiently.

The present invention has been made to address the above drawbacks, and has an object to provide a pseudo defective product data generator capable of efficiently generating many pieces of pseudo defective product data that can contribute to improvement in determination accuracy, with use of a few pieces of defective product data.

In order to achieve the above object, according to a first aspect, a pseudo defective product data generator 11 for generating in a pseudo manner many pieces of defective product data that are external appearance images of an inspected object G to be an abnormal product, the pseudo defective product data generator includes: an actual defective product data acquisition unit (actual defective product data acquisition unit 12 in an embodiment (hereinafter, the same applies in this section)) configured to acquire a plurality of pieces of defective product data of the inspected object that has been actually imaged, respectively as a plurality of pieces of actual defective product data; a first feature quantity conversion unit (first feature quantity conversion unit 13) configured to convert the plurality of pieces of actual defective product data that have been acquired into feature quantities respectively, and to acquire the feature quantities as a plurality of actual feature quantities; a predicted feature quantity generation unit (predicted feature quantity generation unit 14) configured to cause a predetermined feature quantity generation model to learn the plurality of actual feature quantities that have been acquired, and to generate a predicted feature quantity group including predicted feature quantities more than the plurality of actual feature quantities; a pseudo defective product data generation unit (pseudo defective product data generation unit 15) configured to cause a predetermined image generation model to learn the plurality of pieces of actual defective product data that have been acquired, and to generate a pseudo defective product data group including a plurality of pieces of pseudo defective product data more than the plurality of pieces of actual defective product data; a second feature quantity conversion unit (second feature quantity conversion unit 16) configured to convert the plurality of pieces of pseudo defective product data in the pseudo defective product data group that have been generated into feature quantities respectively, and to acquire the feature quantities as a pseudo feature quantity group; a feature quantity distribution comparison unit (feature quantity distribution comparison unit 17) configured to compare distributions between the predicted feature quantity group and the pseudo feature quantity group, and to calculate a feature quantity error as a residual error; and a pseudo defective product data quality determination unit (pseudo defective product data quality determination unit 18) configured to determine a quality of the pseudo defective product data group that has been generated by the pseudo defective product data generation unit, based on the feature quantity error that has been calculated.

According to this configuration, the actual defective product data acquisition unit acquires the plurality of pieces of defective product data of the inspected objects that have been actually imaged, as the plurality of pieces of actual defective product data. In addition, the first feature quantity conversion unit converts the plurality of pieces of actual defective product data into feature quantities respectively, and acquires these feature quantities as the plurality of actual feature quantities. Then, the predicted feature quantity generation unit causes the predetermined feature quantity generation model to learn the above plurality of actual feature quantities and to generate the predicted feature quantity group including the predicted feature quantities more than the actual feature quantities.

On the other hand, the pseudo defective product data generation unit causes the predetermined image generation model to learn the above plurality of pieces of actual defective product data and to generate the pseudo defective product data group including the pseudo defective product data more than the actual defective product data. Further, the second feature quantity conversion unit converts respective pieces of pseudo defective product data in the above pseudo defective product data group into feature quantities, and thus acquires these feature quantities as the pseudo feature quantity group.

The feature quantity distribution comparison unit compares the distribution of the predicted feature quantity group with the distribution the pseudo feature quantity group that have been obtained as described above, and calculates the feature quantity error as the residual error. Then, the pseudo defective product data quality determination unit determines the quality of the pseudo defective product data group that has been generated by the pseudo defective product data generation unit, based on the feature quantity error.

The above predicted feature quantity group has been generated from the actual feature quantities in accordance with the actual defective product data, and thus the one having a high correlation with the actual defective product data is obtained. On the other hand, the above pseudo feature quantity group has been obtained from the pseudo feature quantities of the pseudo defective product data group that has been generated by the pseudo defective product data generation unit. Therefore, in a case where the predicted feature quantity group and the pseudo feature quantity group are compared with each other and the feature quantity error as the residual error of both distributions is relatively small, the pseudo feature quantity group is approximate to the predicted feature quantity group. Therefore, it can be determined that the pseudo defective product data group, which is a conversion source of the pseudo feature quantity group, has a high correlation with the actual defective product data. Then, the pseudo defective product data group is used for the learning by the inspection device having the machine learning function, so that the determination accuracy of the inspection device that determines the quality of the inspected object can be improved.

According to a second aspect, in the pseudo defective product data generator described in the first aspect, in a case where the feature quantity error is equal to or smaller than a predetermined reference value, the pseudo defective product data quality determination unit determines that the pseudo defective product data group is good in quality.

According to this configuration, by appropriately setting the above reference value, in a case where the feature quantity error is equal to or smaller than the reference value, that is, in a case where the feature quantity error is relatively small and the pseudo feature quantity group is approximate to the predicted feature quantity group, it can be determined that the pseudo defective product data group is good in quality, that is, it can contribute to improvement in the determination accuracy of the inspection device that determines the quality of the inspected object.

According to a third aspect, the pseudo defective product data generator described in the second aspect, further includes: a control unit (control unit 19); and a parameter change unit (parameter change unit 20) configured to change a predetermined parameter in the image generation model, in which in a case where the feature quantity error is greater than the reference value, the control unit causes the pseudo defective product data generation unit to repeatedly generate the pseudo defective product data group, while causing the parameter change unit to change the parameter, until the feature quantity error becomes equal to or smaller than the reference value.

According to this configuration, the pseudo defective product data generation unit is controlled by the control unit, and in a case where the feature quantity error is greater than the reference value, the generation of the pseudo defective product data group is repeated by the pseudo defective product data generation unit, while the parameter in the image generation model is being changed, until the feature quantity error becomes equal to or smaller than the reference value. Accordingly, while the parameter change unit is changing the parameter in the image generation model, the pseudo defective product data group with a good quality can be generated.

According to a fourth aspect, the pseudo defective product data generator described in the second aspect further includes: a control unit (control unit 19); a third feature quantity conversion unit (third feature quantity conversion unit 21) configured to convert the plurality of pieces of actual defective product data that have been acquired into feature quantities respectively, and to acquire the feature quantities as the plurality of actual feature quantities; and a feature quantity correction unit (feature quantity correction unit 22) configured to correct the plurality of actual feature quantities respectively, and to acquire a plurality of corrected feature quantities, in which in a case where the feature quantity error is greater than the reference value, the control unit causes the feature quantity correction unit to correct the plurality of actual feature quantities that have been acquired by the third feature quantity conversion unit, by feeding back the feature quantity error that has been calculated by the feature quantity distribution comparison unit, until the feature quantity error becomes equal to or smaller than the reference value, and also causes the pseudo defective product data generation unit to generate the pseudo defective product data group, by causing the image generation model to learn the plurality of corrected feature quantities that have been acquired by the feature quantity correction unit.

According to this configuration, the third feature quantity conversion unit converts the plurality of pieces of actual defective product data into feature quantities respectively, and acquires these feature quantities as the plurality of actual feature quantities. In addition, the feature quantity correction unit corrects the above plurality of actual feature quantities respectively, and thus acquires a plurality of corrected feature quantities.

Then, the feature quantity correction unit and the pseudo defective product data generation unit are controlled by the control unit. In a case where the feature quantity error is greater than the reference value, the feature quantity error that has been calculated is fed back to the feature quantity correction unit until the feature quantity error becomes equal to or smaller than the reference value so as to correct the plurality of actual feature quantities. The image generation model is caused to learn the plurality of corrected feature quantities that have been obtained, and thus the pseudo defective product data generation unit generates the pseudo defective product data group. In this manner, the correction of the plurality of actual feature quantities and the generation of the pseudo defective product data group are repeated, until the feature quantity error becomes equal to or smaller than the reference value. Accordingly, the pseudo defective product data group with a good quality can be automatically generated.

### BRIEF DESCRIPTION OF DRAWINGS

FIG. 1 is a diagram for describing an outline of an inspection system in which pseudo defective product data that has been generated by a pseudo defective product data generator according to an embodiment of the present invention is used for learning;

FIG. 2 is a block diagram illustrating the pseudo defective product data generator according to a first embodiment of the present invention;

FIG. 3 is a flowchart illustrating regeneration processing of the pseudo defective product data;

FIG. 4 is a block diagram illustrating a pseudo defective product data generator according to a second embodiment of the present invention; and

FIG. 5 is a flowchart illustrating automatic generation processing of the pseudo defective product data.

### DETAILED DESCRIPTION

Hereinafter, preferred embodiments of the present invention will be described in detail with reference to the drawings. FIG. 1 illustrates an inspection system including a learning model by which learning has been performed by use of a large number of defective product images that have been generated by a pseudo defective product data generator to be described later and a large number of non-defective product images. Such an inspection system 1 is installed in, for example, a manufacturing factory of vehicle components, and by inspecting the appearance of a vehicle component, automatically determines whether a manufactured vehicle component (for example, a cylinder block) is a normal product (non-defective product) or an abnormal product (defective product). Hereinafter, a vehicle component to be inspected will be referred to as an “inspected object”.

As illustrated in FIG. 1, the inspection system 1 includes a conveyor 2 for conveying an inspected object Gin a predetermined direction at a predetermined speed, and an inspection device 3 for determining the quality of the inspected object G, when the inspected object G reaches a predetermined inspection position. Note that the illustration is omitted, but the inspected object G that has been determined to be a defective product by the inspection device 3 is removed from the conveyor 2, or is conveyed to a storage place dedicated to the defective products.

The inspection device 3 is configured with an information processing device mainly including a computer, and includes a control unit 4, an image acquisition unit 5, a storage unit 6, a learning unit 7, an input unit 8, an output unit 9, and a camera 10.

The control unit 4 includes a CPU, and controls the respective units 5 to 9 of the inspection device 3, and the camera 10. The image acquisition unit 5 acquires, as digital data, an external appearance image of the inspected object G that has been imaged by the camera 10. The storage unit 6 includes a ROM and a RAM, stores various programs to be used in the control of the inspection device 3, and also stores various types of data. The learning unit 7 includes a learning model by which criteria for determining the quality of the inspected object G have been learned. The input unit 8 includes a keyboard and/or a mouse to be operated by an operator, and is configured so that data and/or signals can be input from the outside. The output unit 9 includes a display device such as a display, on which a determination result of the inspected object G is displayed.

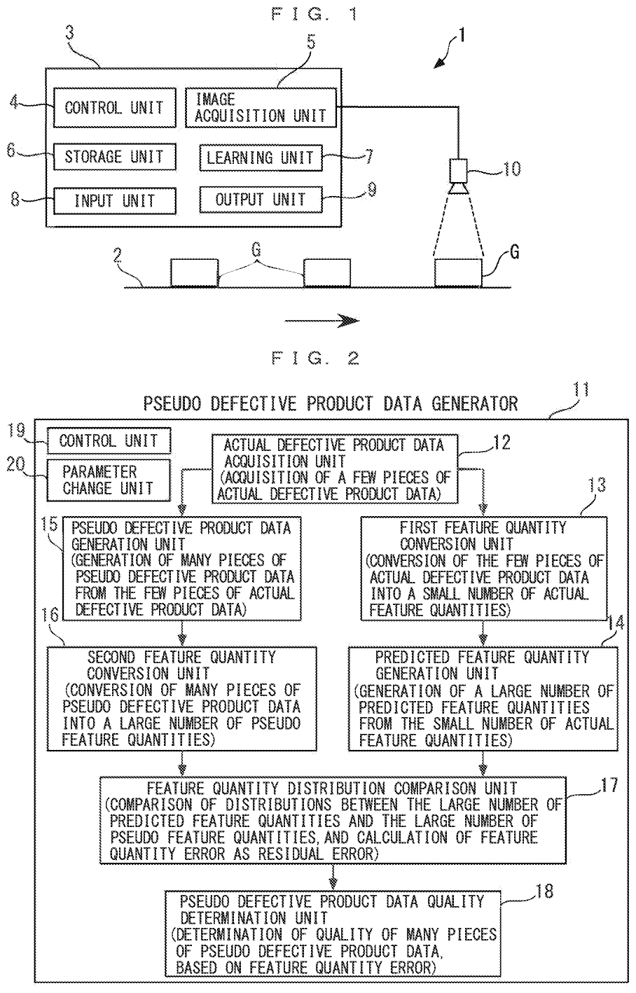

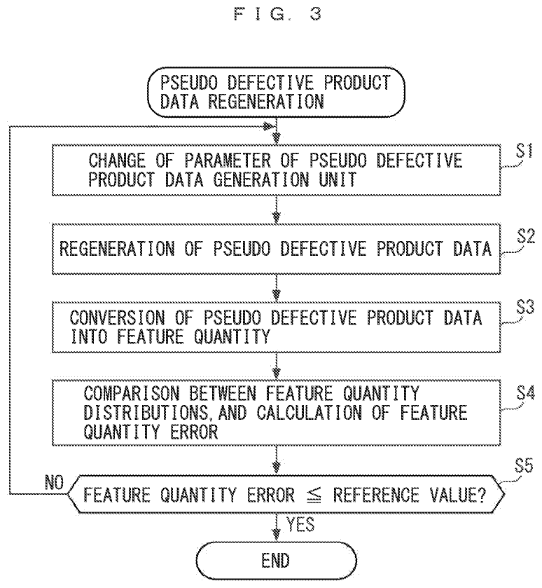

FIG. 2 is a block diagram illustrating a configuration of a pseudo defective product data generator 11 according to a first embodiment of the present invention, and flows of respective pieces of data. As illustrated in the drawing, the pseudo defective product data generator 11 is configured with an information processing device of a computer, and includes an actual defective product data acquisition unit 12 (actual defective product data acquisition unit), a first feature quantity conversion unit 13 (first feature quantity conversion unit), a predicted feature quantity generation unit 14 (predicted feature quantity generation unit), a pseudo defective product data generation unit 15 (pseudo defective product data generation unit), a second feature quantity conversion unit 16 (second feature quantity conversion unit), a feature quantity distribution comparison unit 17 (feature quantity distribution comparison unit), a pseudo defective product data quality determination unit 18 (pseudo defective product data quality determination unit), a control unit 19 (control unit), and a parameter change unit 20 (parameter change unit). Note that the control unit 19 controls the respective units 12 to 18 and 20 of the pseudo defective product data generator 11.

Regarding an external appearance image of the inspected object G, which has been imaged by a camera that is similar to the camera 10 of the inspection device 3 described above, the actual defective product data acquisition unit 12 acquires, as actual defective product data, the one that has been determined to be a defective product by an operator or the like. Then, the actual defective product data acquisition unit 12 acquires relatively a few pieces (for example, 200) of actual defective product data.

The first feature quantity conversion unit 13 converts each of a few pieces of actual defective product data that have been acquired by the actual defective product data acquisition unit 12 into a predetermined feature quantity (hereinafter, referred to as “actual feature quantity”). In this case, the first feature quantity conversion unit 13 converts a few pieces of actual defective product data by use of, for example, scale-invariant feature transform (SIFT) or convolution neural network (CNN), and then acquires a small number of actual feature quantities respectively corresponding to the pieces of actual defective product data.

The predicted feature quantity generation unit 14 generates a large number of feature quantities (hereinafter, referred to as “predicted feature quantity”) from a small number of actual feature quantities that have been acquired by the conversion by the first feature quantity conversion unit 13. Specifically, a feature quantity generation model such as a variational autoencoder (VAE) or a Gaussian mixture VAE (GMVAE) is used to generate a large number of predicted feature quantities (predicted feature quantity group) from a small number of actual feature quantities.

In addition, the pseudo defective product data generation unit 15 generates many pieces of pseudo defective product data from the a few pieces of actual defective product data that have been acquired by the actual defective product data acquisition unit 12 described above. Specifically, an image generation model such as the VAE or deep convolutional generative adversarial networks (DCGAN) of a convolutional neural network is used to generate many pieces of pseudo defective product data (pseudo defective product data group) from a few pieces of actual defective product data.

The second feature quantity conversion unit 16 converts each of many pieces of pseudo defective product data that have been generated by the pseudo defective product data generation unit 15 into a predetermined feature quantity (hereinafter, referred to as “pseudo feature quantity”). Similarly to the first feature quantity conversion unit 13, the second feature quantity conversion unit 16 converts many pieces of pseudo defective product data by use of the SIFT or the CNN, and then acquires a large number of pseudo feature quantities (pseudo feature quantity group) respectively corresponding to the pieces of pseudo defective product data.

The feature quantity distribution comparison unit 17 compares a distribution of the large number of predicted feature quantities that have been generated by the predicted feature quantity generation unit 14 with a distribution of the large number of pseudo feature quantities that have been acquired by conversion by the second feature quantity conversion unit 16, and calculates a feature quantity error as its residual error.

Here, as an example of a feature quantity error calculation procedure, a method for using an error of every N-quartile will be described. For simplification, a case of quartiles of the predicted feature quantity and the pseudo feature quantity will be described as an example. Note that higher-quartiles, for example, 20 quartiles are used in practice.

First, average values of data that respectively fall within a first quartile, a second quartile, a third quartile, and a fourth quartile (more specifically, 0 to 25%, 25 to 50%, 50 to 75%, 75 to 100%) of the predicted feature quantity and the pseudo feature quantity are calculated. The results are denoted as Y25, Y50, Y75, and Y100 for the predicted feature quantities, and X25, X50, X75, and X100 for the pseudo feature quantities. Then, a regression line is drawn from four sets of data (X25, Y25), (X50, Y50), (X75, Y75), and (X100, Y100) with Y as an objective variable and X as an explanatory variable, a predicted feature quantity Y with respect to a pseudo feature quantity X is obtained from the regression line, and a feature quantity error is calculated from a difference between Y and X. As a matter of course, when the value of the predicted feature quantity Y matches the pseudo feature quantity X, the error is 0. Note that the case of a single regression has been described as an example. However, without being limited to such an example, for example, a regression method such as Gaussian process regression may be used.

The pseudo defective product data quality determination unit 18 determines the quality of many pieces of pseudo defective product data that have been generated by the pseudo defective product data generation unit 15, based on the feature quantity error that has been calculated by the feature quantity distribution comparison unit 17.

Specifically, in a case where the feature quantity error is equal to or smaller than a predetermined reference value and the feature quantity error is very small, it is determined that the distribution of many pieces of pseudo feature quantities has high identity to that of the large number of predicted feature quantities, and many pieces of pseudo defective product data that have been generated are good in quality. In this manner, many pieces of pseudo defective product data that have been determined to be good in quality are used for learning by the learning model in the learning unit 7 of the inspection device 3 described above, together with many pieces of non-defective product data. Accordingly, a classification model with high classification accuracy is obtainable as the learning model, and the quality of the inspected object G can be determined accurately in the inspection system 1.

On the other hand, in a case where the feature quantity error is greater than the reference value and the feature quantity error does not become sufficiently small, the pseudo defective product data quality determination unit 18 determines that the distribution of many pieces of pseudo feature quantities has low identity to that of many pieces of predicted feature quantities and the quality of many pieces of pseudo defective product data that has been generated is insufficient. In a case where the determination is made in this manner, the pseudo defective product data generator 11 performs regeneration processing of the pseudo defective product data as follows.

FIG. 3 illustrates the regeneration processing of the pseudo defective product data. In the present processing, first, in step 1 (indicated as “S1” in the drawing. Hereinafter, the same will apply), a parameter of the pseudo defective product data generation unit 15 is changed. Specifically, with use of the parameter change unit 20, a parameter of an image generation model in the pseudo defective product data generation unit 15 is changed manually or automatically. Note that such a parameter is changed so as to reduce the feature quantity error.

Next, the pseudo defective product data is regenerated (step 2). Specifically, the pseudo defective product data generation unit 15, by using the image generation model having the parameter changed in step 1, generates again many pieces of pseudo defective product data (pseudo defective product data group) from the few pieces of actual defective product data that have been already acquired.

Next, the pseudo defective product data is converted into a feature quantity (step 3). Specifically, the second feature quantity conversion unit 16 converts many pieces of pseudo defective product data regenerated in step 2 into a large number of pseudo feature quantities (pseudo feature quantity group).

Next, the feature quantity distributions are compared to calculate a feature quantity error (step 4). Specifically, the feature quantity distribution comparison unit 17 compares the distribution of the large number of predicted feature quantities (predicted feature quantity group) that have been already generated with the distribution of the large number of pseudo feature quantities (pseudo feature quantity group) generated in step 3, and calculates the feature quantity error (step 4).

Then, in step 5, it is determined whether the feature quantity error calculated in step 4 is equal to or smaller than a reference value. In a case where a determination result is YES and the feature quantity error≤the reference value is satisfied, it is determined that many pieces of pseudo defective product data that have been regenerated are good in quality, and the present processing ends.

On the other hand, in a case where the determination result in step 5 is NO and the feature quantity error>the reference value is satisfied, it is determined that many pieces of pseudo defective product data that have been regenerated are insufficient in quality, and steps 1 to 4, which have been described above, are to be performed again. Then, steps 1 to 4 are repeated until the feature quantity error becomes equal to or smaller than the reference value, and finally, many pieces of pseudo defective product data that are good in quality are generated.

As described above, according to the present embodiment, many pieces of pseudo defective product data are generated and a large number of predicted feature quantities are also generated, based on a few pieces of actual defective product data that have been actually acquired. The distribution of the large number of predicted feature quantities is compared with the distribution of the large number of pseudo feature quantities that have been converted from the pseudo defective product data, and a feature quantity error is calculated as a residual error. The quality of many pieces of pseudo defective product data that have been generated can be determined appropriately, based on such a feature quantity error. In addition, in a case where the feature quantity error is greater than a predetermined reference value, the pseudo defective product data generation unit 15 repeatedly generates the pseudo defective product data, while changing the parameter of the image generation model of the pseudo defective product data generation unit 15, until the feature quantity error becomes equal to or smaller than the reference value, so that many pieces of pseudo defective product data that are good in quality can be obtained.

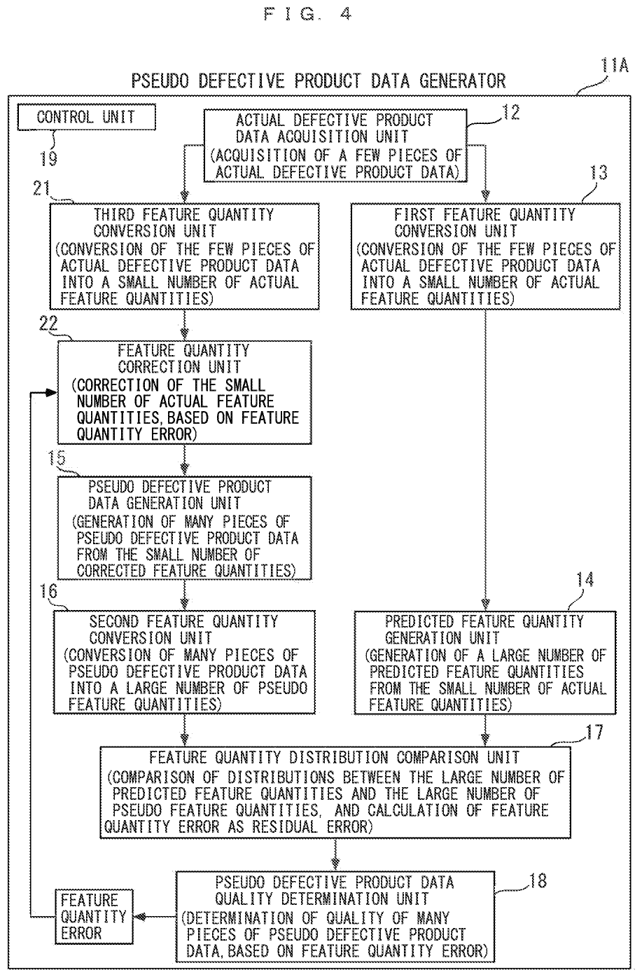

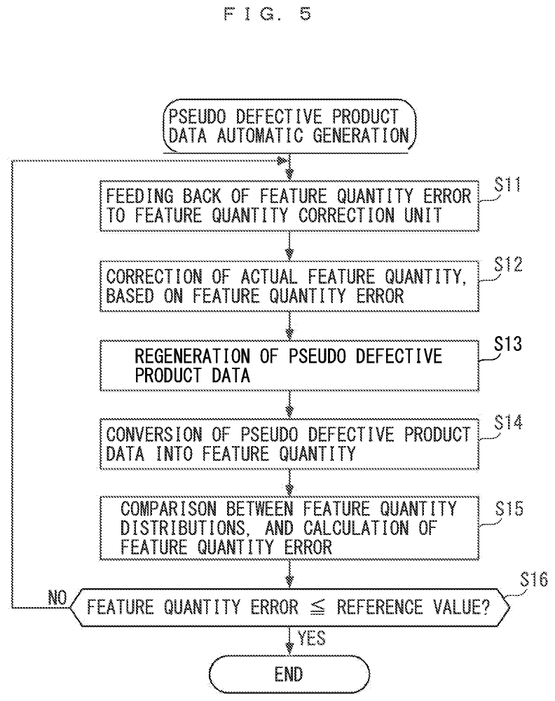

Next, a pseudo defective product data generator 11A according to a second embodiment of the present invention will be described with reference to FIGS. 4 and 5. Note that in the pseudo defective product data generator 11A in the present embodiment, the same components as those of the pseudo defective product data generator 11 in the first embodiment that have been described above are denoted by the same reference numerals, and the detailed descriptions will be omitted.

As illustrated in FIG. 4, similarly to the pseudo defective product data generator 11 in the first embodiment, the pseudo defective product data generator 11A includes the actual defective product data acquisition unit 12, the first feature quantity conversion unit 13, the predicted feature quantity generation unit 14, the pseudo defective product data generation unit 15, the second feature quantity conversion unit 16, the feature quantity distribution comparison unit 17, the pseudo defective product data quality determination unit 18, and the control unit 19. The pseudo defective product data generator 11A further includes a third feature quantity conversion unit 21 (third feature quantity conversion unit) and a feature quantity correction unit 22 (feature quantity correction unit). Note that the control unit 19 controls the third feature quantity conversion unit 21 and the feature quantity correction unit 22 of the pseudo defective product data generator 11A, similarly to the respective units 12 to 18 described above.

The third feature quantity conversion unit 21 in the pseudo defective product data generator 11A is similar to the first feature quantity conversion unit 13. That is, the third feature quantity conversion unit 21 converts a few pieces of actual defective product data that have been acquired by the actual defective product data acquisition unit 12, by use of the SIFT or the CNN, and then acquires a small number of actual feature quantities respectively corresponding to pieces of actual defective product data.

As will be described later, when the feature quantity error is fed back, the feature quantity correction unit 22 corrects the actual feature quantity that has been acquired by the third feature quantity conversion unit 21, based on the feature quantity error. Then, in a case where this correction is conducted, the pseudo defective product data generation unit 15 generates many pieces of pseudo defective product data (pseudo defective product data group) from a small number of feature quantities that have been corrected (corrected feature quantities), by using an image generation model such as the VAE or the DCGAN.

In the pseudo defective product data generator 11A, which is configured in this manner, similarly to the pseudo defective product data generator 11 in the first embodiment, the feature quantity distribution comparison unit 17 compares the distribution of the large number of predicted feature quantities that have been generated by the predicted feature quantity generation unit 14 with the distribution of the large number of pseudo feature quantities that have been acquired by the conversion by the second feature quantity conversion unit 16, and calculates a feature quantity error.

Then, the pseudo defective product data quality determination unit 18 determines the quality of many pieces of pseudo defective product data that have been generated by the pseudo defective product data generation unit 15, based on the feature quantity error that has been calculated by the feature quantity distribution comparison unit 17.

In this case, similarly to the pseudo defective product data generator 11 in the first embodiment, in a case where the feature quantity error is very small, it is determined that many pieces of pseudo defective product data that have been generated are good in quality, and many pieces of pseudo defective product data are used for learning by the learning model in the learning unit 7 of the inspection device 3, together with many pieces of non-defective product data.

On the other hand, in a case where the feature quantity error is greater than the reference value and the feature quantity error is not sufficiently small, the pseudo defective product data quality determination unit 18 determines that many pieces of pseudo defective product data that have been generated are insufficient in quality, and the pseudo defective product data generator 11A performs automatic generation processing of the pseudo defective product data as follows.

FIG. 5 illustrates the automatic generation processing of the pseudo defective product data. In the present processing, first, in step 11, the feature quantity error is fed back to the feature quantity correction unit 22. Specifically, in a case where it is determined that the pieces of pseudo defective product data that have been generated are defective in quality as a determination result by the pseudo defective product data quality determination unit 18, that is, the feature quantity error is greater than the reference value, the feature quantity error is fed back to the feature quantity correction unit 22. Then, the feature quantity correction unit 22 corrects a small number of actual feature quantities that have been acquired by the conversion by the third feature quantity conversion unit 21, based on the feature quantity error that has been fed back (step 12). This correction is conducted so as to reduce the feature quantity error.

Next, the pseudo defective product data is regenerated (step 13). Specifically, the pseudo defective product data generation unit 15 generates many pieces of pseudo defective product data (pseudo defective product data group) from the small number of feature quantities corrected in step 12 (corrected feature quantities).

Next, pieces of the pseudo defective product data are converted into feature quantities (step 14). Specifically, the second feature quantity conversion unit 16 converts many pieces of pseudo defective product data regenerated in step 13 into a large number of pseudo feature quantities (pseudo feature quantity group).

Next, the feature quantity distributions are compared with each other to calculate a feature quantity error (step 15). Specifically, the feature quantity distribution comparison unit 17 compares the distribution of the large number of predicted feature quantities (predicted feature quantity group) that have been already generated with the distribution of the large number of pseudo feature quantities (pseudo feature quantity group) generated in step 14, and calculates the feature quantity error.

Then, in step 16, it is determined whether the feature quantity error calculated in step 15 is equal to or smaller than the reference value. In a case where a determination result is YES and the feature quantity error≤the reference value is satisfied, it is determined that many pieces of pseudo defective product data that have been regenerated are good in quality, and the present processing ends.

On the other hand, in a case where the determination result in step 16 is NO and the feature quantity error>the reference value is satisfied, it is determined that many pieces of regenerated pseudo defective product data are insufficient in quality, and steps 11 to 15 described above are performed again. Then, steps 11 to 15 are repeated, until the feature quantity error becomes equal to or smaller than the reference value, and finally, many pieces of pseudo defective product data that are good in quality are generated.

As described above, according to the present embodiment, similarly to the first embodiment that has been described above, the quality of many pieces of pseudo defective product data that have been generated can be appropriately determined, based on the feature quantity error resulting from the comparison of distributions between the large number of predicted feature quantities and the large number of pseudo feature quantities. When the feature quantity error is greater than the predetermined reference value, the calculated feature quantity error is fed back to the feature quantity correction unit 22 until the feature quantity error becomes equal to or smaller than the reference value, so that a small number of actual feature quantities are corrected, and many pieces of pseudo defective product data are generated by use of the corrected ones. In this manner, the correction of the actual feature quantity and the generation of the pseudo defective product data are repeated until the feature quantity error becomes equal to or smaller than the reference value, so that many pieces of pseudo defective product data that are good in quality can be automatically generated.

Note that the present invention is not limited to the above-described embodiments, and can be implemented in various modes. For example, in an embodiment, the feature quantity distribution comparison unit 17 compares the distribution of the large number of predicted feature quantities with the distribution of the large number of pseudo feature quantities, and determines the quality of many pieces of pseudo defective product data that have been generated, by using the feature quantity error that has been calculated as the residual error. However, by using any other index, it is also possible to determine the quality of the pseudo defective product data that has been generated. In addition, the detailed configurations of the pseudo defective product data generators 11 and 11A, which have been described in the embodiments, are merely examples, and can be appropriately changed within the scope of the gist of the present invention.

What is claimed is:

1. A pseudo defective product data generator for generating in a pseudo manner many pieces of defective product data that are external appearance images of an inspected object to be an abnormal product, the pseudo defective product data generator comprising:
an actual defective product data acquisition unit configured to acquire a plurality of pieces of defective product data of the inspected object that has been actually imaged, respectively as a plurality of pieces of actual defective product data;
a first feature quantity conversion unit configured to convert the plurality of pieces of actual defective product data that have been acquired into feature quantities respectively, and to acquire the feature quantities as a plurality of actual feature quantities;
a predicted feature quantity generation unit configured to cause a predetermined feature quantity generation model to learn the plurality of actual feature quantities that have been acquired, and to generate a predicted feature quantity group including predicted feature quantities more than the plurality of actual feature quantities;
a pseudo defective product data generation unit configured to cause a predetermined image generation model to learn the plurality of pieces of actual defective product data that have been acquired, and to generate a pseudo defective product data group including a plurality of pieces of pseudo defective product data more than the plurality of pieces of actual defective product data;
a second feature quantity conversion unit configured to convert the plurality of pieces of pseudo defective product data in the pseudo defective product data group that have been generated into feature quantities respectively, and to acquire the feature quantities as a pseudo feature quantity group;
a feature quantity distribution comparison unit configured to compare distributions between the predicted feature quantity group and the pseudo feature quantity group, and to calculate a feature quantity error as a residual error; and
a pseudo defective product data quality determination unit configured to determine a quality of the pseudo defective product data group that has been generated by the pseudo defective product data generation unit, based on the feature quantity error that has been calculated.

2. The pseudo defective product data generator according to claim 1, wherein in a case where the feature quantity error is equal to or smaller than a predetermined reference value, the pseudo defective product data quality determination unit determines that the pseudo defective product data group is good in quality.

3. The pseudo defective product data generator according to claim 2, further comprising:
a control unit; and
a parameter change unit configured to change a predetermined parameter in the image generation model, wherein
in a case where the feature quantity error is greater than the reference value, the control unit causes the pseudo defective product data generation unit to repeatedly generate the pseudo defective product data group, while causing the parameter change unit to change the parameter, until the feature quantity error becomes equal to or smaller than the reference value.

4. The pseudo defective product data generator according to claim 2, further comprising:
a control unit;
a third feature quantity conversion unit configured to convert the plurality of pieces of actual defective product data that have been acquired into feature quantities respectively, and to acquire the feature quantities as the plurality of actual feature quantities; and
a feature quantity correction unit configured to correct the plurality of actual feature quantities respectively, and to acquire a plurality of corrected feature quantities, wherein
in a case where the feature quantity error is greater than the reference value, the control unit causes the feature quantity correction unit to correct the plurality of actual feature quantities that have been acquired by the third feature quantity conversion unit, by feeding back the feature quantity error that has been calculated by the feature quantity distribution comparison unit, until the feature quantity error becomes equal to or smaller than the reference value, and also causes the pseudo defective product data generation unit to generate the pseudo defective product data group, by causing the image generation model to learn the plurality of corrected feature quantities that have been acquired by the feature quantity correction unit.
